(19) United States
(12) Patent Application Publication
(10) Pub. No.: US 2026/0203807 A1
(43) Pub. Date: Jul. 16, 2026

(54) Loss prevention by correlating in-store activities with at-checkout activities

(71) Applicant: Trigo Vision Ltd., Ramat Gan (IL)

(72) Inventors: Eyal Daniel, Ramat Gan (IL); Elad Malka, Tel Aviv (IL); Erez Mordehay Hay Gerby, Herzeliya (IL); Amit Kol, Tel Aviv (IL); Gilad Dym, Rehovot (IL); Gilad Erlich, Tel Aviv (IL); Guy Lapid, Ness Ziona (IL); Ido Marcus, Tel Aviv (IL); Jonathan Zanger, Tel Aviv (IL); Lihi-Ahuva Shiloh Perl, Ramat Gan (IL); Shaked Dolev, Tel-Aviv (IL)

(21) Appl. No.: 19/046,556

(22) Filed: Feb. 6, 2025

Related U.S. Application Data
(60) Provisional application No. 63/743,661, filed on Jan. 10, 2025.

(51) Int. Cl. G06Q 30/0601; G06T 7/20; G06V 10/44; G06V 10/764; G06V 20/52; G06V 40/20

(52) U.S. Cl. CPC G06Q 30/0633; G06Q 30/0641; G06T 7/20; G06V 10/44; G06V 10/764; G06V 20/52; G06V 40/20; G06V 2201/07

(57) ABSTRACT

System and method for loss prevention by: processing a first set of images captured by a first set of cameras and depicting interactions between first persons and products in a store, classifying an interaction as one of taking a product or returning a product; identifying a first product taken by a first person and adding the first product to a virtual shopping cart associated with the first person; reidentifying the first person in a checkout area of the store based on a second set of images captured by a second set of cameras; obtaining a scan list for the first person comprising products scanned for the first person; comparing the virtual shopping cart to the scan list; and generating a notification upon determining a discrepancy between the virtual shopping cart and the scan list.

### CROSS-REFERENCE TO RELATED APPLICATION

This application claims the benefit of U.S. Provisional Application No. 63/743,661 filed Jan. 10, 2025.

### FIELD OF THE INVENTION

The present invention relates generally to retail loss prevention, and particularly to methods and systems for retail loss prevention by correlating in-store activities with at-checkout activities.

### BACKGROUND OF THE INVENTION

Retail loss prevention in the context of this disclosure refers to preventing shrinkage in a physical, retail store environment by identifying when a shopper takes a product and does not pay for it, either intentionally or unintentionally.

U.S. Pat. No. 11,049,170 entitled “CHECKOUT FLOWS FOR AUTONOMOUS STORES” describes, in an autonomous checkout retail store, analyzing a first set of images collected by a first set of tracking cameras and creating a virtual shopping cart for a first user without requiring the first user to establish an identity with the autonomous store. The virtual shopping cart is updated with a set of items based on observations from a set of sensors of interactions between the first user and the set of items. A checkout operation is performed automatically on the set of items in the virtual shopping cart upon the first user being detected within the proximity of a checkout location in the store.

U.S. Patent Publication 2024/0169735A1 entitled “SYSTEM AND METHOD FOR PREVENTING SHRINKAGE IN A RETAIL ENVIRONMENT USING REAL TIME CAMERA FEEDS” relates to detecting shrinkage in a retail store. This reference describes, in a physical retail store, using real time camera feeds to identify, in a first set of images captured by tracking cameras, one or more product objects in association with one or more person objects. The one or more product objects in association with the one or more person objects are reidentified in a second set of images captured by a second set of cameras that tracks the movement of the one or more product objects in the retail store. An activity associated with the movement of the one or more product objects is classified to prevent retail shrinkage, where the activity includes a scan activity, an in-bag activity, a no-scan activity, a mis-scan activity, or a theft activity.

### SUMMARY OF THE INVENTION

In accordance with certain aspects of the presently disclosed subject matter there is a provided a method comprising processing a first set of images captured by a first set of cameras and depicting interactions between first persons and products in a store, said processing to (a) extract features of the first set of images, (b) apply an embedding model to features of first persons, (c) apply a first trained classifier to features of interactions, and (d) apply a second trained classifier to features of products, wherein an interaction is classified as one of taking a product or returning a product; identifying, based on said processing, a first product taken by a first person and adding the first product to a virtual shopping cart associated with the first person; reidentifying the first person in a checkout area of the store based on a second set of images captured by a second set of cameras; obtaining, from a computer connected to a checkout terminal, a scan list for the first person, the scan list comprising products scanned for the first person; comparing the virtual shopping cart to the scan list; and generating a notification upon determining a discrepancy between the virtual shopping cart and the scan list.

In accordance with further aspects and optionally in combination with other aspects, the method comprises sending the notification to a device operated by a store supervisor and/or sending the notification to a display of a checkout terminal.

In accordance with further aspects and optionally in combination with other aspects, the notification contains information regarding the discrepancy, the information indicating at least one of: a product in the virtual shopping cart is not in the scan list, a product in the scan list is not in the virtual shopping cart, a quantity of a product in the virtual shopping is greater than a quantity of the product in the scan list, and a quantity of a product in the virtual shopping is less than a quantity of the product in the scan list.

In accordance with further aspects and optionally in combination with other aspects the checkout area of the store includes one or both of (a) in a vicinity of a checkout terminal of the store, and (b) in a vicinity of an exit of the store.

In accordance with further aspects and optionally in combination with other aspects reidentifying the first person in the second set of images comprises: extracting features of a second person from the second set of images; applying the embedding model to the features extracted from the second set of images to generate a descriptor of the second person from the second set of images; comparing the descriptor generated for the second person from the second set of images to one or more descriptors that were generated for the first person from the first set of images; and based on results of the comparing, determining that the second person in the second set of images is the first person in the first set of images.

In accordance with further aspects and optionally in combination with other aspects the method further comprises tracking the first person across multiple images captured by a third set of cameras covering different fields of view (FOV) of the store, wherein the tracking is performed at least in part using FOV mapping data that describes spatial and temporal relationships between the different FOVs.

In accordance with further aspects and optionally in combination with other aspects the method further comprises generating the FOV mapping data, by, during a time period prior to the tracking: processing a plurality of images captured during the time period by the first set of cameras to generate descriptors for persons depicted in the plurality of images; and identifying recurring patterns of movement of similar descriptors within or between FOVs of different cameras of the first set of cameras to thereby learn the spatial and temporal relationships between the different FOVs.

In accordance with certain aspects of the presently disclosed subject matter there is a provided a system comprising a non-transitory computer readable memory; and a processor communicatively coupled to the memory, the processor configured to perform operations of: processing a first set of images captured by a first set of cameras and depicting interactions between first persons and products in a store, said processing to (a) extract features of the first set of images, (b) apply an embedding model to features of first persons, (c) apply a first trained classifier to features of interactions, and (d) apply a second trained classifier to features of products, wherein an interaction is classified as one of taking a product or returning a product; identifying, based on said processing, a first product taken by a first person and adding the first product to a virtual shopping cart associated with the first person; reidentifying the first person in a checkout area of the store based on a second set of images captured by a second set of cameras; obtaining, from a computer connected to a checkout terminal, a scan list for the first person, the scan list comprising products scanned for the first person; comparing the virtual shopping cart to the scan list; and generating a notification upon determining a discrepancy between the virtual shopping cart and the scan list.

In accordance with further aspects and optionally in combination with other aspects the operations include sending the notification to a device operated by a store supervisor and/or sending the notification to a display of a checkout terminal.

In accordance with further aspects and optionally in combination with other aspects the operations include tracking the first person across multiple images captured by a third set of cameras covering different fields of view (FOV) of the store, wherein the tracking is performed at least in part using FOV mapping data that describes spatial and temporal relationships between the different FOVs.

In accordance with further aspects and optionally in combination with other aspects the operations include generating the FOV mapping data, by, during a time period prior to the tracking: processing a plurality of images captured during the time period by the first set of cameras to generate descriptors for persons depicted in the plurality of images; and identifying recurring patterns of movement of similar descriptors within or between FOVs of different cameras of the first set of cameras to thereby learn the spatial and temporal relationships between the different FOVs.

In accordance with certain aspects of the presently disclosed subject matter there is a provided a non-transitory storage medium comprising instructions that when executed by a processor, cause the processor to perform operations of: processing a first set of images captured by a first set of cameras and depicting interactions between first persons and products in a store, said processing to (a) extract features of the first set of images, (b) apply an embedding model to features of first persons, (c) apply a first trained classifier to features of interactions, and (d) apply a second trained classifier to features of products, wherein an interaction is classified as one of taking a product or returning a product; identifying, based on said processing, a first product taken by a first person and adding the first product to a virtual shopping cart associated with the first person; reidentifying the first person in a checkout area of the store based on a second set of images captured by a second set of cameras; obtaining, from a computer connected to a checkout terminal, a scan list for the first person, the scan list comprising products scanned for the first person; comparing the virtual shopping cart to the scan list; and generating a notification upon determining a discrepancy between the virtual shopping cart and the scan list.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a retail loss prevention system, in accordance with an embodiment of the present invention;

FIG. 2 illustrates processing images 102A from shelf monitoring cameras 102B, in accordance with an embodiment of the present invention;

FIG. 3 illustrates processing images 104A from checkout monitoring cameras 104B to reidentify persons at checkout and generating a notification if a loss prevention opportunity is identified, in accordance with an embodiment of the present invention;

FIG. 4 shows a generalized flow chart of operations of a method of retail loss prevention by correlating in-store activities with at-checkout activities, in accordance with an embodiment of the present invention;

FIG. 5 shows an example top down view of the real world space of a store covered by tracking cameras, in accordance with an embodiment of the present invention;

FIG. 6 shows an example of generating and saving tracks, in accordance with an embodiment of the present invention;

FIG. 7 shows a generalized flow chart of operations of a method of learning and describing spatial and/or temporal relationships between respective Fields of View (FOVs) of a plurality of tracking cameras, in accordance with an embodiment of the present invention; and

FIG. 8 shows a generalized flow chart of operations of a method of reidentifying persons in images captured by a plurality of tracking cameras, in accordance with an embodiment of the present invention.

### DETAILED DESCRIPTION OF EMBODIMENTS

### Overview

Embodiments of the present invention that are described herein provide methods and systems for loss prevention in stores. In particular, the retail loss prevention system can be implemented in regular, non-autonomous stores, and can be implemented using a store's existing cameras to identify when products are about to be removed from the store without payment. Furthermore, there is no requirement to either detect at the checkout the product about to be removed or to classify a scan activity at checkout.

An example disclosed system identifies loss prevention opportunities in physical, “brick and mortar”, stores using cameras and image analysis. The system can use cameras already installed in the store as part of the store's pre-existing security setup. Additionally, some loss prevention opportunities can be identified even where store cameras provide less than full coverage of the store. Furthermore, shoppers are not asked or required to identify themselves to the system.

A first set of cameras captures images (e.g. frames of a video) of shoppers in a shopping area of the store and interactions between shoppers and products on shelves. A server located on or off premises receives and processes the images in real-time using machine learning techniques to detect the shopper, detect and classify the interaction, and identify the product. Shoppers are anonymously described using an embedding model applied to image features. An embedding model generates a numerical descriptor of an object, e.g. a person, shown in an image or set of images based on features extracted from a part of the image or images where the object appears. An example of a descriptor is an embedding vector, or simply “embedding”. Therefore, the terms “descriptor” and “embedding” may be used interchangeably throughout this description.

Interactions are detected and classified into one of several classifications including taking a product from the shelf and returning a product to the shelf.

Products are identified by matching to products commonly sold in stores, e.g. using image analysis and pattern matching techniques. Product identification can optionally be enhanced with data regarding the specific products sold in the store, but such data is unnecessary. Based on coverage needs and available camera coverage, the system analyzes images from the cameras in real time and adds and/or removes products from the shopper's virtual shopping cart generated by the system, without requiring the shopper to engage with the system at all.

A second set of cameras captures images (e.g. frames of a video feed) of shoppers in a checkout area of the store, e.g. at a checkout terminal (whether manned or unmanned) or exit. The server receives and processes these images in real-time using machine learning techniques, and shoppers are reidentified. The virtual shopping cart for a given shopper is compared with the products that were actually scanned by that shopper, or scanned by a store colleague for that shopper, at a checkout terminal during checkout. In case of a discrepancy, a notification is generated and sent to one or more devices to be viewed by a person.

Notifications can be sent to a store supervisor (e.g. via a device operated by the supervisor), the shopper (e.g. via a display on the checkout terminal), or both. Notifications can be sent in real-time or as part of an offline system. Notifications can include information about the discrepancy, including a list of products that were not scanned, photos of products not scanned, incorrect quantities scanned, etc. The contents, communication channel, and/or recipient of the notification can be implemented differently according to the specific needs of the particular store.

It will be appreciated by those skilled in the art that the disclosed method and system is not limited to only retail stores, and in fact is equally applicable to non-retail environments as well, e.g. wholesale stores, showrooms, etc. or anywhere products are sold or checked out.

Another aspect of the disclosed subject matter relates to methods and systems for tracking and reidentifying persons captured in images using learned spatial and/or temporal relationships between tracking cameras to enhance and improve the reidentification process. This method of tracking and reidentification is referred to herein as “sparse tracking”. In a learning mode, the system processes images captured by tracking cameras in the store, and applies an embedding model to generate embeddings for persons depicted in the images. Each embedding is associated with a camera identifier and a time stamp. The system applies a distance metric to pairs of embeddings from different cameras, and analyzes pairs of embeddings that have a distance metric within a certain threshold distance. By analyzing a large number of such pairs, the system “learns” the spatial and/or temporal relationship between pairs of cameras, for example the degree of overlap and/or a transition time between cameras. The system generates mapping data describing the spatial and/or temporal relationships between cameras. The mapping data is further used to generate a set of constraints for reidentifying persons in different cameras.

In operation, the system processes, in real-time, images captured by the tracking cameras to generate embeddings representing persons and tracks representing two-dimensional motions of persons (as represented by one or more embeddings) within a field of view of a camera. A start and end time of each motion are recorded and associated with the track. For each ended track, the system attempts to associate the ended track to a person already associated with one or more other tracks by comparing the description of the person (as represented by one or more embeddings) of the ended track to descriptions of candidate persons associated with other tracks. The candidate persons are selected based on the candidate persons' tracks and the ended track's camera identifier, start time and end time aligning with the mapping data that describes the spatial and/or temporal relationships between cameras and/or the set of constraints generated from the mapping data. Similarity scores are computed for embeddings of the person of the ended track and embeddings of candidate persons, and the person of the ended track is associated with the candidate person with the highest similarity score that is above a minimum threshold score, thereby reidentifying the person. This technique can be used to determine, with high likelihood, that a shopper identified interacting with a shelf, a shopper captured in images from cameras without interactions with shelves, and a shopper identified at a checkout area are the same shopper

The principles and operation of a retail loss prevention system according to the presently disclosed subject matter may be better understood with reference to the drawings and the accompanying description.

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, components have not been described in detail so as not to obscure the presently disclosed subject matter.

Unless specifically stated otherwise, as apparent from the following discussions, it is appreciated that throughout the specification discussions utilizing terms such as “processing”, “extracting”, “associating”, “training”, “obtaining”, “determining”, “generating”, “identifying”, “comparing”, “storing”, “selecting” or the like, refer to the action(s) and/or process(es) of a computer that manipulate and/or transform data into other data, said data represented as physical, such as electronic, quantities and/or said data representing the physical objects. The terms “computer” and “processor” should be expansively construed to cover any kind of electronic device with data processing capabilities including, by way of non-limiting example, the retail loss prevention system disclosed in the present application.

It is to be understood that the term “non-transitory” is used herein to exclude transitory, propagating signals, but to include, otherwise, any volatile or non-volatile computer memory technology suitable to the presently disclosed subject matter.

The operations in accordance with the teachings herein can be performed by a computer specially constructed for the desired purposes or by a general-purpose computer specially configured for the desired purpose by a computer program stored in a computer readable storage medium.

The references cited in the background teach many principles of retail loss prevention that may be applicable to the presently disclosed subject matter. Therefore, the full contents of these publications are incorporated by reference herein where appropriate for appropriate teachings of additional or alternative details, features and/or technical background.

Embodiments of the presently disclosed subject matter are not described with reference to any particular programming language. It will be appreciated that a variety of programming languages can be used to implement the teachings of the presently disclosed subject matter as described herein.

### System Description

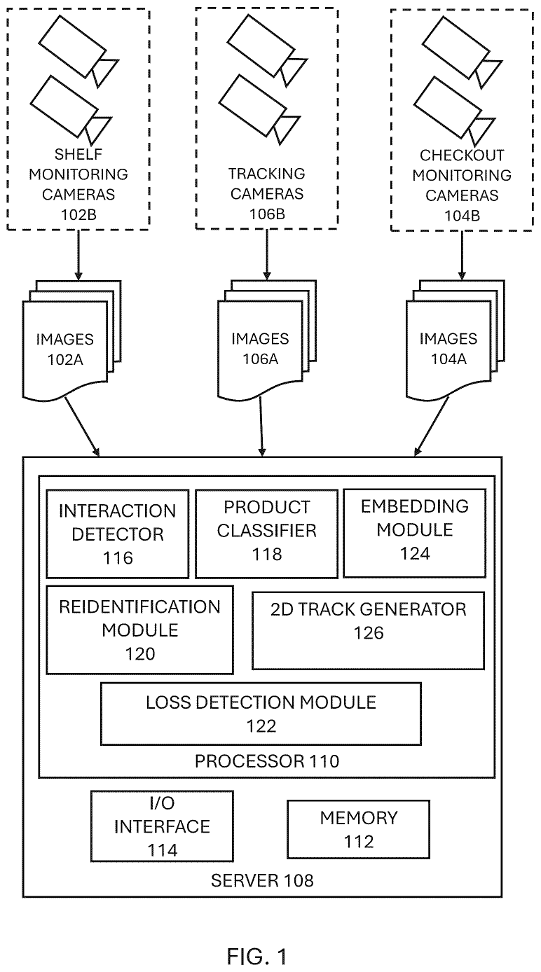

Reference is initially made to FIG. 1, which is a schematic illustration of a system for retail loss prevention, in accordance with some embodiments of the present invention. The system includes a server 108 configured to receive a first set of one or more images 102A captured from a first set of one or more cameras 102B (hereinafter referred to as “shelf monitoring cameras 102B”) and a second set of images 104A from a second set of one or more cameras 104B (hereinafter referred to as “checkout monitoring cameras 104B”). In some embodiments, as will be detailed below, server 108 also receives a third set of images 106A captured by a third set of cameras 106B (hereinafter referred to as “tracking cameras 106B”). The first, second, and third set of images can be, e.g. frames of respective video feeds captured by respective cameras.

Server 108 includes one or more processors 110 (which are for clarity hereinafter referred to as simply processor 110) configured to execute computer-executable instructions, a memory 112 for storing data and/or instructions to be executed by processor 110, an I/O interface 114 configured to receive input (e.g. images 102A and 104A) for processing by processor 110 and to send output (e.g. notifications) as may be generated by processor 110. Each of processor 110, memory 112, and I/O interface 114 are communicatively coupled to one another. The term “communicatively coupled” should be understood to include all suitable forms of wired and/or wireless data connections which enable the transfer of data between connected devices or between various components of a single device. It should be noted that in practice the operations attributed to server 108 can be split between one or more different servers. Additionally, the server or servers (as the case may be) can be located on-premises or in the cloud, or, in the case of multiple servers, some servers may be located on-premises while other servers may be located in the cloud.

Memory 112 can be, e.g., non-volatile memory. I/O interface 114 can send and receive data over a network. In some cases, I/O interface can be connectable to one or more output devices such as a display (not shown), and one or more input devices such as a mouse and keyboard (not shown).

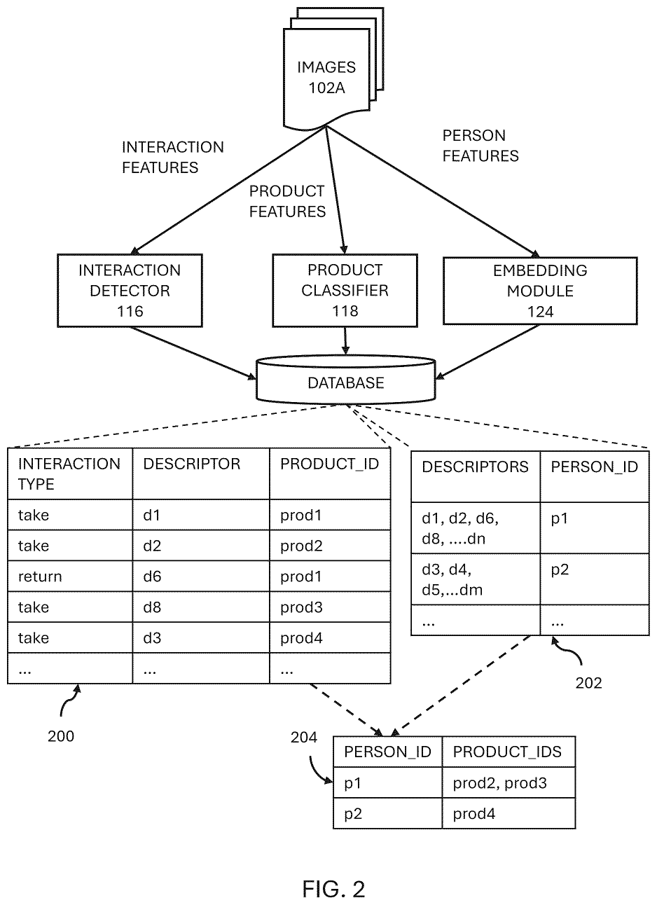

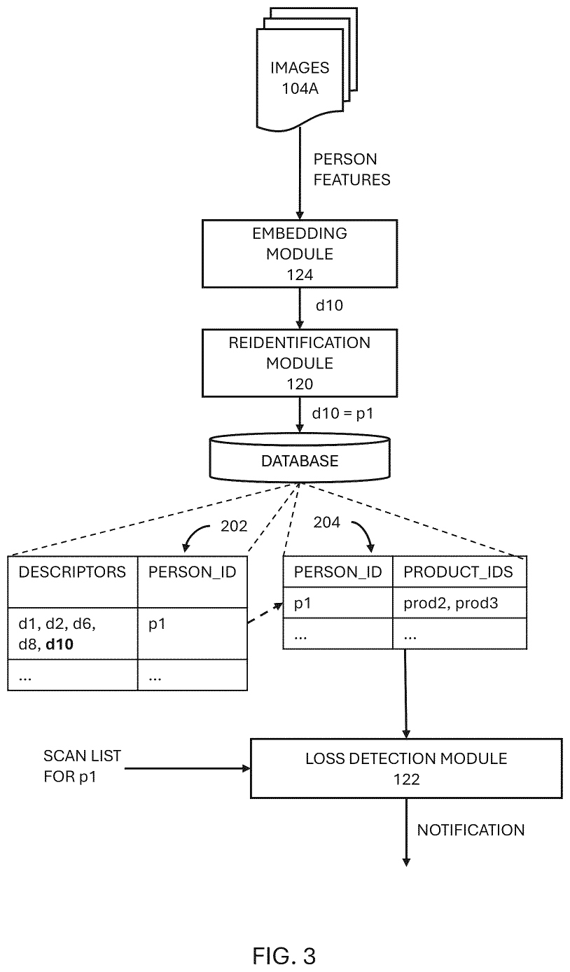

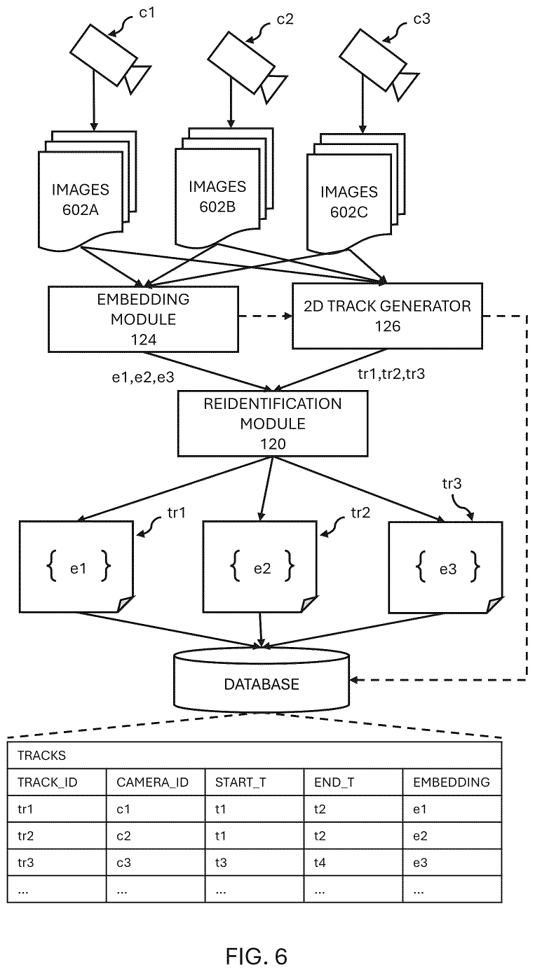

Processor 110 includes various functional modules for performing operations of retail loss prevention. By way of non-limiting example, processor 110 includes interaction detector 116, product classifier 118, and embedding module 124 that process images, 2D track generator 126 that generates tracks from images, and reidentification module 120 that reidentifies persons captured in different images. Processor 110 also includes loss detection module 122 configured to identify loss prevention opportunities and generate notifications. The operations of interaction detector 116, product classifier 118, embedding module 124 and reidentification module 120 are further described with reference to FIG. 2. The operations of loss detection module 122 are further described with reference to FIG. 3. The operations of 2D track generator 126 are further described with reference to FIG. 6.

FIG. 2 illustrates processing images 102A from shelf monitoring cameras 102B according to some embodiments. As described above, images 102A show a plurality of shoppers (also referred to herein as “persons”) interacting with a plurality of products for sale. For example, a shopper may take a product from a shelf, examine the product, and either keep or return the product to the shelf. It should be appreciated that not all of images 102A will show interactions between persons and products, such that in practice only a subset of images 102A are processed as described below. For brevity, images 102A should be understood to include a subset of images 102A in which interactions between persons and products are depicted. These images are processed further in order to better understand the interaction and, if necessary, to link the interaction with the given person and given product. Processor 110 processes images 102A by extracting i) features of the interaction (“interaction features”), ii) features of the person (“person features”), and iii) features of the product (“product features”). Processor 110 further processes the interactions features, product features, and person features using interaction detector 116, product classifier 118, and embedding module 124, respectively.

Interaction detector 116 detects and classifies interactions by analyzing the interaction features of a depicted interaction between the given person and given product. Interaction detector 116 classifies the interaction into one of several different interaction types. Interaction types include, e.g. a “take” interaction type where the depicted interaction is indicative of the person taking the product, and a “return” interaction type where the depicted interaction is indicative of the person returning the product. In some embodiments, interaction detector 116 can be implemented as a first machine-learning model that was trained using a labeled dataset of images depicting different interaction types.

Product classifier 118 analyzes the product features of the given product and identifies the specific product. The specific product is uniquely identified, e.g. using a Stock Keeping Unit (SKU) or other product identifier. In some embodiments, product classifier 118 can be implemented as a second machine-learning model that was trained using a labeled dataset of images depicting different products that are commonly sold in stores. In some cases, if product classifier 118 is unable to uniquely identify the product (e.g. due to poor image quality, obstructions, etc.), product classifier 118 may instead identify two or more possible candidate products for later review, e.g. by a store supervisor, or may identify a product category associated with the product (e.g. “a bottle of an alcoholic beverage” without specifying a particular alcoholic beverage).

Methods of training and using classifiers to identify interaction types and products are known. For example, Deep Neural Networks (DNNs) as well as other machine-learning algorithms can be used to classify interactions and products in images.

Embedding module 124 analyzes the person features of the given person and applies an embedding model to the features to generate a descriptor (i.e. a numerical representation of an appearance of a person in an image) for the given person.

Applying embedding models to generate descriptors for persons appearing in images are known. Briefly, due to differences in the way a person appears in different images and different camera views, many different descriptors may be generated for the same person. Descriptors are generated by applying an embedding model to person features to generate a vector representation of the person's appearance. Since each descriptor is an n-dimensional vector, the proximity of different descriptors can be mathematically computed, and descriptors that are sufficiently proximate in an n^{th}-dimensional vector space can be assumed to describe the same person to a certain degree of probability.

Reidentification module 120 assigns or associates a descriptor to a person, as represented by a person identifier. A person identifier is a randomly or pseudo-randomly generated identifier that uniquely and anonymously “identifies” a given person internally in the loss prevention system. Initially, the descriptor may be assigned a new person identifier. Subsequently, the person identifier may be updated to reflect a reidentification. Reidentification takes place when a person depicted in different images (including from different cameras) is determined to be the same person based on having matching descriptors. Descriptors “match” when the vector space proximity between the descriptors is less than a predetermined threshold. Each time a new descriptor is determined to match an existing descriptor, the new descriptor is assigned the same person identifier as the existing descriptor. Thus, for example, a given person can be associated with a plurality of different, yet similar, descriptors but only a single person identifier. The process of assigning a descriptor to an existing person identifier is sometimes referred to as “reidentifying” the person. Some of these methods are already known. Other, novel, methods for reidentifying persons are discussed below.

As will be discussed below with reference to FIG. 3, embedding module 124 also generates descriptors for persons appearing in images 104A captured by checkout monitoring cameras 104B. For clarity, descriptors generated from images 102A captured by shelf monitoring cameras 102B are referred to below as “first descriptors” and are used to describe “first persons”, while descriptors generated from images 104A captured by checkout monitoring cameras 104B are referred to below as “second descriptors” and are used to describe “second persons”. In some embodiments, as discussed below, embedding module 124 also processes images 106A from tracking cameras 106B by generating descriptors of persons appearing in images 106B to enhance the reidentification process.

Processor 110 stores, for a given interaction between a given person and a given product, the interaction type, product identifier and person identifier in a data repository. Processor 110 also generates and stores data reflecting virtual shopping carts for respective persons in the store. The virtual shopping cart is updated whenever a “take” or “return” interaction is identified, by adding or removing the product to/from the virtual shopping cart. For brevity, the data repository is shown and referred to as a “database”, though this is not to be taken as limiting in any way, and those skilled in the art will appreciate that any suitable data repository can be used, including e.g. non-volatile memory such as memory 112.

By way of non-limiting example, FIG. 2 shows an interactions table 200 and a persons table 202. Interactions table 200 records and associates interaction types to first descriptors and products, while persons table 202 records and associates person identifiers to first descriptors. The combined data from these two tables can be used to associate virtual shopping carts with persons. For example, virtual shopping cart table 204 records and associates each person with a list of products taken by that person (including quantity where more than one of the same product is taken). Thus, for example, in FIG. 2 a person represented by the person identifier “p1” is associated with first descriptors d1, d2, d6 and d8. In turn, first descriptors d1, d2, d6 and d8 are respectively associated with “taking” products prod1, prod2, prod3, and “returning” prod1. Therefore, virtual shopping cart table 204 records data indicating that person “p1” is associated with a virtual shopping cart consisting of products prod2 and prod3 as well as their respective quantities (for brevity, quantities are not shown).

Persons skilled in the art will appreciate that the example described above in shown in FIG. 2 represents only one of many possible ways of recording and associating relevant data and generating virtual shopping carts, and this example should not be taken as limiting in any way. For example, other types of data structures or objects (e.g. JavaScript Object Notation (JSON) objects, etc.) could be used to record the data.

FIG. 3 illustrates processing images 104A from checkout monitoring cameras 104B to reidentify persons at checkout and generating a notification if a loss prevention opportunity is identified. As described above, images 104A show second persons at a checkout area of the store, e.g. at a checkout terminal or store exit. As used herein, “checkout terminal” should be understood to include any device, system, or computer where products for purchase by a customer are scanned and a store checkout is transacted, including e.g. a validation station used in “scan and go” type stores in which the shopper's list of self-scanned products is validated. The checkout terminal could be manned (e.g. by an agent such as a cashier) or unmanned (e.g. a self-checkout terminal).

Processor 110 processes images 104A by extracting person features of second persons checking out or, in some cases, leaving the store after having checkout or without having checked out (hereinafter collectively referred to as “second persons”). Embedding module 124 analyzes the extracted person features and generates second descriptors for second persons. The second descriptors are compared to first descriptors that were generated from images 102A (i.e. images of persons shopping) and were associated with person identifiers. Second descriptors are matched to first descriptors, thereby reidentifying the first person as the same person as the second person. Comparing descriptors and identifying matches were discussed above with reference to FIG. 2, and the same process applies here as well.

By way of non-limiting example, FIG. 3 shows embedding module 124 generating second descriptor d10. Reidentification module 120 determines that d10 matches at least one of first descriptor d1, d2, d6, and d8, and associates (e.g. in persons table 202) d10 with the same person identifier (i.e. “p1”) that d1, d2, d6, and d8 are associated with, thereby reidentifying person “p1” in images 104A from checkout monitoring cameras 104B that show person “p1” checking out.

Assuming reidentification is successful, (i.e. a match is found between the second descriptor and at least one first descriptor), loss detection module 122 obtains data, referred to herein as a “scan list”, indicative of the products and quantities that were scanned or otherwise entered into a store checkout system for the reidentified person. The scan list can be obtained from a checkout terminal, or a computer connected to a checkout terminal. Loss detection module 122 compares the scan list to the virtual shopping cart for the person, e.g. by comparing product identifiers (e.g. SKUs) and quantities in the scan list and in the virtual shopping cart.

In FIG. 3, p1's virtual shopping cart is shown as a row in virtual shopping cart table 204 in which p1 is associated with products prod2 and prod3. For brevity, quantities are omitted from FIG. 3, though it will be appreciated that quantities of each product are also stored in the virtual shopping cart.

In case of a discrepancy between the scan list and the virtual shopping cart, loss detection module 122 generates a notification indicative of the discrepancy.

Depending on the desired implementation, some types of discrepancies may trigger a notification while other types of discrepancies may not trigger a notification. For example, in case of a discrepancy in which products in the virtual shopping cart are not in the scan list, or a lesser quantity of the product is in the scan list, a notification may be generated since shrinkage is likely to occur. By contrast, if the scan list includes more products than the virtual shopping cart, or greater quantity of a product, shrinkage is not likely to occur and therefore a notification may not be generated. In other implementations, a notification may be generated each time a discrepancy is identified, though the information contained in the notification could be different for different kinds of discrepancies. Additionally, the communication channel, recipient, or other aspects of the notification could differ based on discrepancy type. The notification can be sent to a device of a store supervisor, a display of a checkout terminal, or both. The notification can indicate the discrepancy between the virtual shopping cart and the scan list, and can include additional information related to the discrepancy, e.g. product identifier(s), product photo(s), etc.

In some cases, other types of notifications could be generated as well. For example, loss detection module 122 may generate a notification in the case that one or more products in the virtual shopping cart could not be identified with a sufficient degree of certainty. For example, there may be cases where product classifier 118 determines that a product appearing in an image can be one of several different products. In this case, loss detection module 122 may generate a notification indicating that a loss prevention opportunity cannot be determined because the person took a product that could not be identified with certainty. In this case, the notification may include an indication of one or more possible products that the person may have taken but could not be determined with certainty. The notification may prompt a supervisor to provide feedback as to which of the products were actually taken. In some cases, the feedback can be used to further train the product classifier by augmenting the training data with the feedback. In some embodiments, a notification could be generated when a person attempts to shoplift, e.g. by reidentifying a person in the vicinity of the store exit without having scanned any items (i.e. the “scan list” for the person is null or empty).

It should be appreciated that the loss prevention system described herein does not need to provide a 100% detection rate of loss prevention opportunities in order to be advantageous. Various limitations such as camera coverage, training data, image quality, etc. may cause some losses to go undetected. Even so, given the large amount of shrinkage experienced by stores, even partial recovery could amount to a large savings for a retailer, potentially even millions of dollars a year. This is especially true since the system uses cameras already installed and in use by the retailer, so that the upfront investment for a retailer to implement the described system can be minimal relative to the potential savings.

### Flow Chart of Retail Loss Prevention

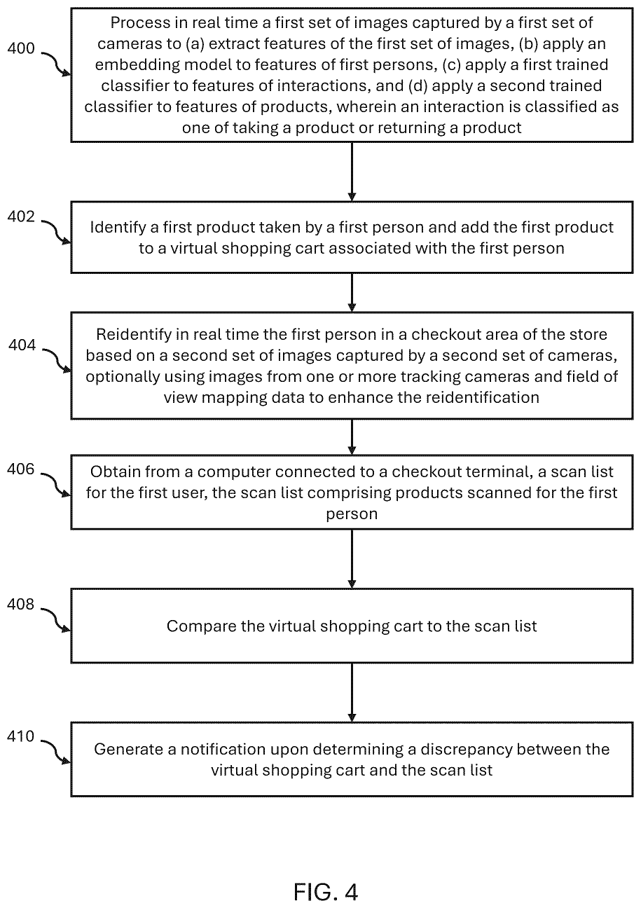

FIG. 4 shows a generalized flow chart of operations of a method of retail loss prevention by correlating in-store activities with at-checkout activities.

At operation 400, processor 110 processes, in real time, a first set of images captured by a first set of cameras and depicting interactions between first persons and products for sale in a store. Images can be processed in real time or at a later time. The processing includes (a) extracting features of the first set of images, (b) applying an embedding model to features of first persons to generate descriptors associated with first persons, (c) applying a first trained classifier to features of interactions to classify interaction types, and (d) applying a second trained classifier to features of products to identify products in the images. Interactions can be classified as a take interaction or a return interaction.

At operation 402, based on the processing, processor 110 identifies a first product taken by a first person and adds the first product to a virtual shopping cart associated with the first person. As described above, the identifying includes associating a descriptor generated for the first person to a randomly generated person identifier.

At operation 404, processor 110 reidentifies, in real time, the first person in a second set of images captured by a second set of cameras subsequent to the capture of the first set of images by the first set of cameras. The second set of images depicting the first person proximate to a checkout area of the store. In some embodiments, as described below, reidentification also uses images from one or more tracking cameras and field of view mapping data to improve and enhance the process and/or accuracy of the reidentification.

At operation 406, processor 110 obtains a scan list for the first person from a computer connected to a checkout terminal. The scan list includes products scanned for the first person.

At operation 408, processor 110 compares the virtual shopping cart to the scan list, including e.g. comparing the quantities of specific products in the virtual shopping cart and in the scan list.

At operation 410, processor 110 generates a notification upon determining a discrepancy between the virtual shopping cart and the scan list. As discussed above, the type of notification could depend on the type of discrepancy, and the format, communication channel, and recipient of the notification could depend on the type of discrepancy or the specific needs of the store as may be implemented by the store.

It should be noted that while reference is made to “real time” processing of images to detect and notify of loss prevention opportunities, the invention is not limited to real time processing. Offline processing of images to detect retail loss “after the fact” (e.g. after the customer leaves the store) is also possible and within the scope of this disclosure.

### Reidentification Enhanced by Camera Connectivity Graph

Another aspect of the presently disclosed subject matter relates to methods of reidentifying and tracking persons moving in a physical area monitored by different cameras using a sparse tracking system which combines matching persons based on representative image features and using a learned model describing spatial and/or temporal relationships between cameras. The sparse tracking system disclosed herein anonymously tracks persons, via multiple reidentifications, based on general image features of the person. The system consists of two modes, a learning mode and a production mode.

### Learning Mode

In this mode, the sparse tracking system “learns” spatial and temporal relationships between different cameras' areas of coverage of the store. The physical area of the store (“footprint”) covered by a given camera is referred to herein as the given camera's field of view (FOV). A pair of cameras with overlapping areas of coverage are said to have overlapping FOVs. In the learning mode, the system learns or predicts which cameras have overlapping FOVs as well as the degree of overlap. Additionally, the system learns or predicts a distribution of transition times between the FOVs of a pair of cameras with no overlap. A transition time refers to how long it takes (e.g. on average) for a subject, after leaving a first camera's FOV, to appear in a given second camera's FOV. The learned or predicted degree of overlap and/or transition time between pairs of cameras are referred to herein as the spatial and/or temporal relationship between the cameras. These relationships are learned by processing images of subjects moving around the store and observing statistically significant patterns.

For example, the system can recognize a pattern in which the same one or more subjects (as anonymously described via one or more descriptors) tend to appear in multiple cameras at the same time, or within a predictable time difference.

To learn these spatial and/or temporal relationships the system processes a set of images that were captured by in-store tracking cameras during a fixed given time period representing the learning stage. The in-store tracking cameras can include shelf monitoring cameras 102B and/or checkout monitoring cameras 104B and/or tracking cameras 106B. The captured images that show persons shopping in the store are isolated and analyzed further. First, embeddings are generated for persons based on image features of the person's appearance in images. Embeddings are continually generated for all persons in the store from all cameras. Each embedding is associated with a time stamp and a camera identifier. Embeddings are extracted continually over a relatively long time period, e.g. several days. In some cases, hundreds of thousands of embeddings can be extracted during the time period.

The system then calculates similarity scores (e.g. a numerical score between 0-1) for pairs of embeddings from different cameras. A pair of embeddings with a similarity score above a threshold are considered to be similar enough and might be the same person. The system analyzes the similarity scores calculated for a large number of different pairs of embeddings in order to identify statistically significant patterns of when similar embeddings appear at the same time, or at a predictable time offset, in two or more different camera FOVs. These patterns are then used to identify spatial and/or temporal relationships between the FOVs of the different cameras in the pairs including, e.g., whether or not a pair of cameras' respective FOVs overlap, the degree of overlap (e.g. expressed using a numerical value (e.g. 0-1) to represent the amount of overlap) a distribution (e.g. a histogram) of transition times (also referred to as a “time offset”) between a pair cameras' respective FOVs (e.g. 1 second, 2, seconds, etc.). In some embodiments, the system can calculate an initial similarity score and a reference or baseline score between pairs of cameras (e.g. to account for randomness), with the final similarity score being calculated as the difference between the initial score and the reference score.

The system then generates a camera connectivity graph (also referred to herein as “FOV mapping data”) that describes the learned spatial and/or temporal relationships between the in-store tracking cameras. The FOV mapping data could be represented as one or more graphs, tables, data objects, etc. For example, a set of nodes could represent the set of cameras, and the mapping data could be expressed as an edge value between pairs of nodes. For example, an edge value could represent the degree of overlap and/or transition time.

In some embodiments, the system may use the FOV mapping data to generate a set of constraints to be used for narrowing the list of potential candidates when reidentifying persons captured by the different cameras.

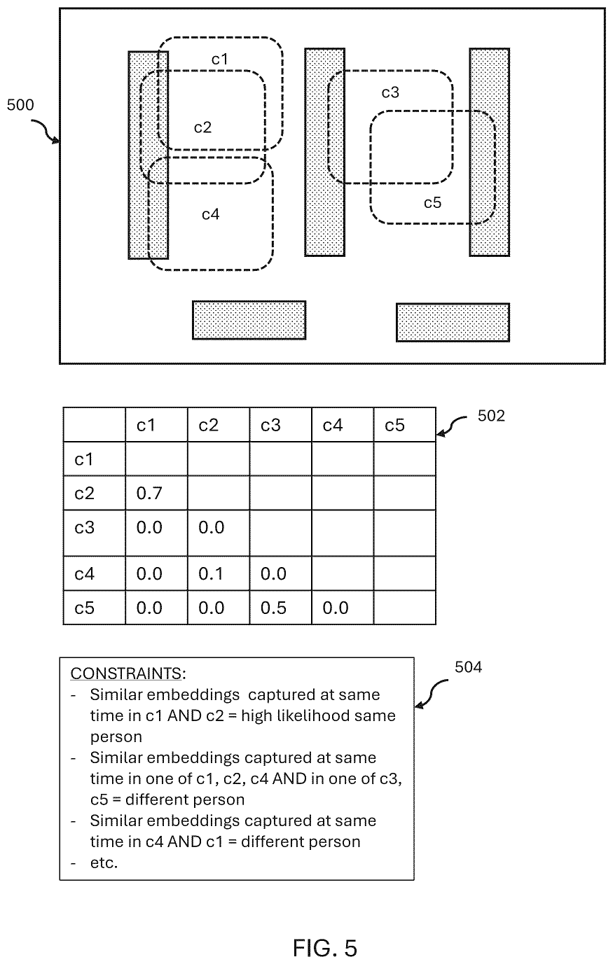

By way of non-limiting example, FIG. 5 shows an example top down view of the real world space 500 of a store covered by tracking cameras c1, c2, c3, c4, and c5 in which each camera's respective FOV is marked. As shown, cameras c1 and c2 have partially overlapping FOVs, as does the pair of cameras c2 and c4, and the pair c3 and c5. On the other hand, cameras c1 and c4 have no overlap with one another, and none of c1, c2 and c4 overlap with either c3 or c5. FOV mapping data 502 describes the degree of overlap with respect to each pair of cameras, and constraints 504 show an example set of constraints for reidentifying persons moving within real world space 500 based on spatial and/or temporal relationships described by FOV mapping data 502. The constraints could be “hard” constraints, i.e. a person either is or isn't the same person, or “soft” constraints, i.e. a person is more or less likely to be the same person, where the “likelihood” is assessed via probability using different weighting schemes based on the mapping data.

### Production Mode

In production mode (also referred to as “operational mode” or “in operation”), reidentification of persons appearing in the tracking cameras is enhanced with the learned spatial and/or temporal relationships between FOVs as described by the FOV mapping data that was generated in the learning mode.

As shoppers move about the store, tracking cameras (e.g. tracking cameras 106B and/or shelf monitoring cameras 102B and/or checkout monitoring cameras 104B) capture images of the shoppers. Images from each camera in which a person is depicted are isolated for further analysis. These images are processed by embedding module 124 to generate embeddings, each of which is representative of a person's appearance within a particular FOV of a particular camera. 2D track generator 126 generates “tracks” from the images. A “track” is data that describes a two-dimensional motion (also referred to as “movement”) of a person within a particular FOV between a given start time and end time. A person's 2D motion can be extracted by using the person's 2D geometric motion on the image frame, possibly enhanced by using the similarity of embeddings generated in different time stamps, as discussed below. Reidentification module 120 associates the tracks generated by 2D track generator 126 to the embeddings generated by embedding module 124 such that each track includes data that indicates, e.g., one or more embeddings, an identifier that uniquely identifies the particular tracking camera (“camera identifier”) that captured the images used to generate the track, and a time component of the movement including at least a start time (“track start time”) and an end time (“track start time”), respectively indicating the start and end time of the movement. The track and its associated information can be recorded, e.g. in a table or data object (e.g. JSON object) along with a unique track identifier. During any given time period, processor 110, e.g. 2D track generator 126, separately generates and saves many tracks, each of which is associated with a specific two-dimensional movement of a specific person within a FOV of a specific camera.

FIG. 6 shows an example of generating and saving tracks. Tracking cameras c1, c2, and c3 each capture a set of images 602A, 602B, and 602C, respectively, depicting persons in a store. Embedding module 124 processes i) images 602A to generate embedding e1 representing a first person, ii) images 602B to generate embedding e2 representing a second person, and iii) images 602C to generate embedding e3 representing a third person. The first, second and third persons may be the same person or different persons. 2D track generator 126 also processes i) images 602A to generate track tr1 associated with the two-dimensional motion of a person, ii) images 602B to generate track tr2 associated with the two-dimensional motion of a person, and iii) images 602C to generate track tr3 associated with the two-dimensional motion of a person. The persons associated with tr1, tr2, and tr3 may be the same person or different persons. Reidentification module 120 associates track tr1 with embedding e1, track tr2 with embedding e2, track tr3 with embedding e3, and stores the information in a database. Alternatively, as shown via dashed lines, 2D track generator 126 obtains embeddings from embedding module 124, uses the embeddings to enhance the track generation (e.g. by using the similarity of embeddings in addition to tracking the geometric movement of a 2D object), associates embeddings to tracks, and saves the tracks to the database. Note that for simplicity, FIG. 6 shows a single embedding generated for a person and associated with a track. In practice, multiple embeddings representing the same person can be generated for that person and associated with a single track representing the 2D movement of that person.

To reidentify persons captured in different cameras, initially reidentification module 120 associates each track with a new person (i.e. by generating and assigning a new, randomly generated unique person identifier to the track). For each ended track, reidentification module 120 attempts to match the person associated with the ended track to a person associated with a previous track by comparing one or more embeddings associated with the person associated with ended track to embeddings of candidate persons associated with previous tracks. Reidentification module 120 calculates a similarity score indicative of the closeness of each comparison, and selects the candidate person with the highest similarity score above a certain threshold as the most likely match. Reidentification module 120 then updates the person identifier of the ended track to reflect the same person identifier as the matching candidate person.

If none of the similarity scores meet the threshold (indicating there is likely no match), it is assumed that the ended track is associated with a new person, and accordingly reidentification module 120 does not update the new person identifier.

In some embodiments, since a person may be associated with many different yet similar embeddings based on differences in how the person appears in different images, a single representative or “prototype” embedding may be calculated for the person as a summary or average of all known embeddings associated with that person. In some cases, several prototype embeddings may be calculated for a single person. For example, one prototype embedding may represent a summary of embeddings of the person viewed from the front, while a second prototype embedding may represent a summary of embeddings of the person viewed from the back, etc. In this case, each time a person is reidentified, the person's one or more prototype embeddings are recalculated based on all known embeddings, optionally using a clustering algorithm to separately calculate prototype embeddings for different groups of embeddings (e.g. a group of “front” embeddings and a group of “back” embeddings). These prototype embeddings are then associated with the tracks of that person.

Thereafter, for subsequent reidentifications, embeddings of ended tracks only need to be compared to the prototype embeddings of a candidate person, thereby reducing the number of comparisons that need to be made. Reducing the number of representative embeddings for a specific person is advantageous for two main reasons. Firstly, in order to limit the comparisons that need to be made overall, thereby saving computing resources (e.g. processing power, memory, etc.). Secondly, in order to increase the robustness of the system to misleading embeddings (for example, of obstructed people) and to potential previous association mistakes of the reidentification module.

Reidentification module 120 uses the FOV mapping data to narrow down the candidate list of persons that need to be compared to the person associated with the ended track by selecting candidate persons whose associated tracks align with the learned and/or predicted spatial and temporal relationships between the different cameras as described in the mapping data (e.g. respective track's camera identifiers, start times and end times align or correspond to the overlap or transition times between the respective FOVs of the cameras). In some embodiments, the FOV mapping data can be used directly, e.g. to eliminate potential persons as candidates. In other cases, the FOV mapping data can be used indirectly, e.g. to infer a set of rules or constraints for assigning a probability that a potential person is a candidate, including assigning different weights to different potential persons. As a simple example of using constraints to narrow down the list of candidate persons, consider the tracks indicated in FIG. 6 and the set of constraints 504. In this case, the pair of tracks tr1, tr2 may relate to the same person since these motions were captured at the same time (i.e. between t1 and t2) from overlapping cameras (i.e. c1 and c2). Therefore, embeddings e1 and e2 are candidates for comparison. On the other hand, embeddings e2 and e3 are only candidates for comparison if the time offset between t2 and t3 corresponds to the transition time between cameras c2 and c3.

### Flow Chart of Reidentifying Persons

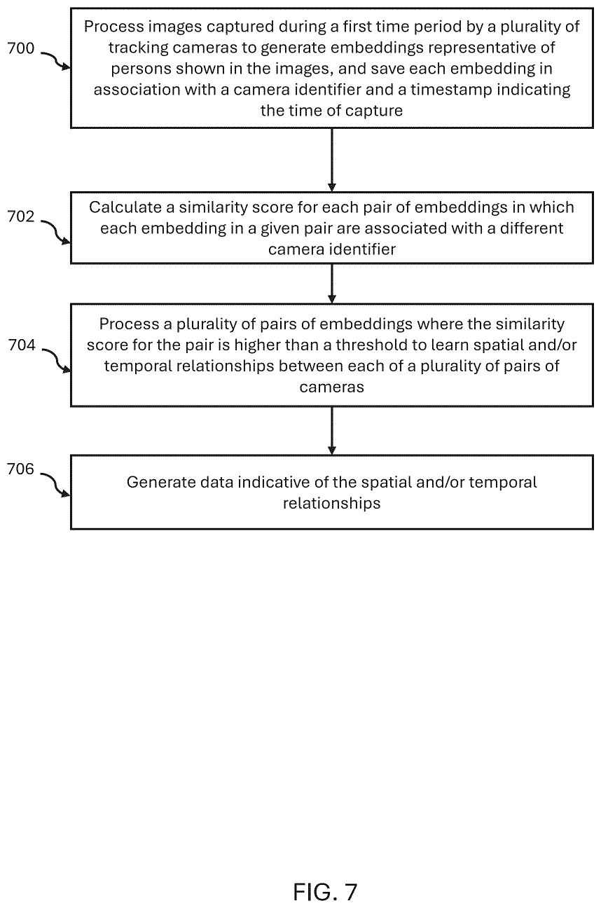

FIG. 7 shows a generalized flow chart of operations of a method of learning and describing spatial and/or temporal relationships between respective FOVs of a plurality of tracking cameras.

At operation 700, processor 110 processes images captured during a first time period by a plurality of tracking cameras to generate embeddings representative of persons shown in the images, and saves each embedding in association with a camera identifier and a timestamp indicating the time of capture.

At operation 702, processor 110 calculates a similarity score for each pair of embeddings in which each embedding in a given pair is associated with a different camera identifier.

At operation 704, processor 110 processes a plurality of pairs of embeddings where the similarity score for the pair is higher than a threshold to learn spatial and/or temporal relationships between each of a plurality of pairs of cameras by observing repeating patterns that collectively indicate a given spatial and/or temporal relationship between one or more given pairs of cameras.

At operation 706, processor 110 generates data indicative of the spatial and/or temporal relationships between respective FOVs of the different cameras.

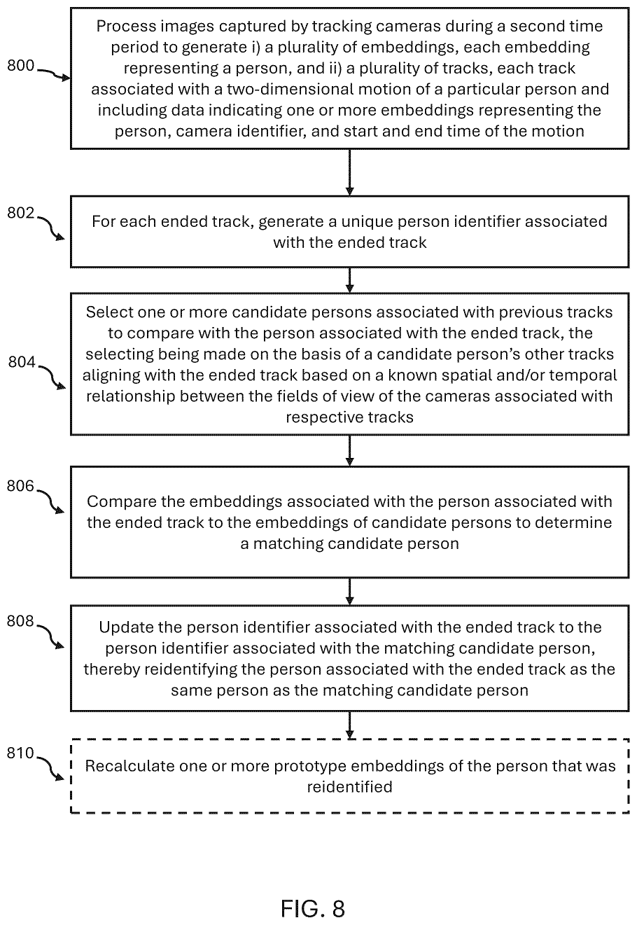

FIG. 8 shows a generalized flow chart of operations of a method of reidentifying persons in images captured by a plurality of tracking cameras.

At operation 800, processor 110 processes images captured by tracking cameras during a second time period to generate i) a plurality of embeddings, each embedding representing a person, and ii) a plurality of tracks, each track associated with a two-dimensional motion of a particular person as represented by one or more embeddings. Each track includes or is associated with data indicating the one or more embeddings, a camera identifier, and a start and end time of the motion.

At operation 802, processor 110 generates, for each ended track, a unique person identifier associated with the ended track.

At operation 804, processor 110 selects one or more candidate persons associated with previous tracks for comparison with the person associated with the ended track. Candidate persons are selected on the basis of a candidate person's previous tracks aligning with the ended track such that the respective tracks' camera identifier, start time and end time correspond to known spatial and/or temporal relationships between the fields of view of the respective cameras.

At operation 806, processor 110 compares the embeddings of the ended track to the embeddings of the candidate persons people to determine a match based on a similarity score computed for the compared embeddings being the highest score that exceeds a minimum threshold score. In some embodiments, as discussed above, the embeddings of the ended track are compared to one or more prototype embeddings of the candidate persons.

At operation 808, processor 110 updates the person identifier associated with the ended track to match the person identifier associated with the previous track(s) of the matching candidate person, thereby reidentifying the person associated with the ended track as the same person as the matching candidate person.

In embodiments that implement prototype embeddings, at operation 810, processor 110 calculates or recalculates one or more prototype embeddings based on all known embeddings of the person that was reidentified and associates the one or more prototype embeddings to the tracks associated with that person.

It is noted that the teachings of the presently disclosed subject matter are not bound by the specific system described with reference to FIG. 1. Equivalent and/or modified functionality can be consolidated or divided in another manner and can be implemented in any appropriate combination of software, firmware and/or hardware. The processor can be implemented as a suitably programmed computer. The functions of the processor can be, at least partially, integrated with the first set of cameras and/or the second set of cameras and/or the third set of cameras.

Although the embodiments described herein mainly address loss prevention and reidentification of shoppers in a store, the methods and systems described herein can also be used in other applications, such as in surveillance, tracking of objects other than persons, and learning spatiotemporal relationships between cameras in a collection of cameras

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method comprising:
processing a first set of images captured by a first set of cameras and depicting interactions between first persons and products in a store, said processing to (a) extract features of the first set of images, (b) apply an embedding model to features of first persons, (c) apply a first trained classifier to features of interactions, and (d) apply a second trained classifier to features of products, wherein an interaction is classified as one of taking a product or returning a product;
identifying, based on said processing, a first product taken by a first person and adding the first product to a virtual shopping cart associated with the first person;
reidentifying the first person in a checkout area of the store based on a second set of images captured by a second set of cameras;
obtaining, from a computer connected to a checkout terminal, a scan list for the first person, the scan list comprising products scanned for the first person;
comparing the virtual shopping cart to the scan list; and
generating a notification upon determining a discrepancy between the virtual shopping cart and the scan list.

2. The method of claim 1, further comprising:
sending the notification to a device operated by a store supervisor.

3. The method of claim 1, further comprising:
sending the notification to a display of a checkout terminal.

4. The method of claim 1, wherein the notification contains information regarding the discrepancy, the information indicating at least one of:
(a) a product in the virtual shopping cart is not in the scan list,
(b) a product in the scan list is not in the virtual shopping cart,
(c) a quantity of a product in the virtual shopping is greater than a quantity of the product in the scan list, and
(d) a quantity of a product in the virtual shopping is less than a quantity of the product in the scan list.

5. The method of claim 1, wherein the checkout area of the store includes one or both of (a) in a vicinity of a checkout terminal of the store, and (b) in a vicinity of an exit of the store.

6. The method of claim 1, wherein reidentifying the first person in the second set of images comprises:
extracting features of a second person from the second set of images;
applying the embedding model to the features extracted from the second set of images to generate a descriptor of the second person from the second set of images;
comparing the descriptor generated for the second person from the second set of images to one or more descriptors that were generated for the first person from the first set of images; and
based on results of the comparing, determining that the second person in the second set of images is the first person in the first set of images.

7. The method of claim 1, further comprising:
tracking the first person across multiple images captured by a third set of cameras covering different fields of view (FOV) of the store, wherein the tracking is performed at least in part using FOV mapping data that describes spatial and temporal relationships between the different FOVs.

8. The method of claim 7, further comprising:
generating the FOV mapping data, by, during a time period prior to the tracking:
processing a plurality of images captured during the time period by the first set of cameras to generate descriptors for persons depicted in the plurality of images; and
identifying recurring patterns of movement of similar descriptors within or between FOVs of different cameras of the first set of cameras to thereby learn the spatial and temporal relationships between the different FOVs.

9. A system comprising:
a non-transitory computer readable memory; and
a processor communicatively coupled to the memory, the processor configured to perform operations of:
processing a first set of images captured by a first set of cameras and depicting interactions between first persons and products in a store, said processing to (a) extract features of the first set of images, (b) apply an embedding model to features of first persons, (c) apply a first trained classifier to features of interactions, and (d) apply a second trained classifier to features of products, wherein an interaction is classified as one of taking a product or returning a product;
identifying, based on said processing, a first product taken by a first person and adding the first product to a virtual shopping cart associated with the first person;
reidentifying the first person in a checkout area of the store based on a second set of images captured by a second set of cameras;
obtaining, from a computer connected to a checkout terminal, a scan list for the first person, the scan list comprising products scanned for the first person;
comparing the virtual shopping cart to the scan list; and
generating a notification upon determining a discrepancy between the virtual shopping cart and the scan list.

10. The system of claim 9, the operations further comprising:
sending the notification to a device operated by a store supervisor.

11. The system of claim 9, the operations further comprising:
sending the notification to a display of a checkout terminal.

12. The system of claim 9, wherein the notification contains information regarding the discrepancy, the information indicating at least one of:
(a) a product in the virtual shopping cart is not in the scan list,
(b) a product in the scan list is not in the virtual shopping cart,
(c) a quantity of a product in the virtual shopping is greater than a quantity of the product in the scan list, and
(d) a quantity of a product in the virtual shopping is less than a quantity of the product in the scan list.

13. The system of claim 9, wherein the checkout area of the store includes one or more of (a) in a vicinity of a checkout terminal of the store, and (b) in a vicinity of an exit of the store.

14. The system of claim 9, wherein reidentifying the first person in the second set of images comprises:
extracting features of a second person from the second set of images;
applying the embedding model to the features extracted from the second set of images to generate a descriptor of the second person from the second set of images;
comparing the descriptor generated for the second person from the second set of images to one or more descriptors that were generated for the first person from the first set of images; and
based on results of the comparing, determining that the second person in the second set of images is the first person in the first set of images.

15. The system of claim 9, the operations further comprising:
tracking the first person across multiple images captured by a third set of cameras covering different fields of view (FOV) of the store, wherein the tracking is performed at least in part using FOV mapping data that describes spatial and temporal relationships between the different FOVs.

16. The system of claim 15, the operations further comprising:
generating the FOV mapping data, by, during a time period prior to the tracking:
processing a plurality of images captured during the time period by the first set of cameras to generate descriptors for persons depicted in the plurality of images; and
identifying recurring patterns of movement of similar descriptors within or between FOVs of different cameras of the first set of cameras to thereby learn the spatial and temporal relationships between the different FOVs.

17. A non-transitory storage medium comprising instructions that when executed by a processor, cause the processor to perform operations of:
processing a first set of images captured by a first set of cameras and depicting interactions between first persons and products in a store, said processing to (a) extract features of the first set of images, (b) apply an embedding model to features of first persons, (c) apply a first trained classifier to features of interactions, and (d) apply a second trained classifier to features of products, wherein an interaction is classified as one of taking a product or returning a product;
identifying, based on said processing, a first product taken by a first person and adding the first product to a virtual shopping cart associated with the first person;
reidentifying the first person in a checkout area of the store based on a second set of images captured by a second set of cameras;
obtaining, from a computer connected to a checkout terminal, a scan list for the first person, the scan list comprising products scanned for the first person;
comparing the virtual shopping cart to the scan list; and
generating a notification upon determining a discrepancy between the virtual shopping cart and the scan list.

18. The medium of claim 17, wherein reidentifying the first person in the second set of images comprises:
extracting features of a second person from the second set of images;
applying the embedding model to the features extracted from the second set of images to generate a descriptor of the second person from the second set of images;
comparing the descriptor generated for the second person from the second set of images to one or more descriptors that were generated for the first person from the first set of images; and
based on results of the comparing, determining that the second person in the second set of images is the first person in the first set of images.

19. The medium of claim 18, the operations further comprising:
tracking the first person across multiple images captured by a third set of cameras covering different fields of view (FOV) of the store, wherein the tracking is performed at least in part using FOV mapping data that describes spatial and temporal relationships between the different FOVs.

20. The medium of claim 19, the operations further comprising:
generating the FOV mapping data, by, during a time period prior to the tracking:
processing a plurality of images captured during the time period by the first set of cameras to generate descriptors for persons depicted in the plurality of images; and
identifying recurring patterns of movement of similar descriptors within or between FOVs of different cameras of the first set of cameras to thereby learn the spatial and temporal relationships between the different FOVs.
